(19) United States
(12) Patent Application Publication
(10) Pub. No.: US 2009/0214773 A1
(43) Pub. Date: Aug. 27, 2009

(54) Diffusion Coating Systems with Binders that Enhance Coating Gas

(75) Inventors: Todd S. Moran, Simpsonville, SC (US); Dennis W. Cavanaugh, Simpsonville, SC (US); Matthew James O'Connell, Simpsonville, SC (US)

Correspondence Address: SUTHERLAND ASBILL & BRENNAN LLP, 999 PEACHTREE STREET, N.E., ATLANTA, GA, 30309, US

(73) Assignee: GENERAL ELECTRIC COMPANY, Schenectady, NY (US)

(21) Appl. No.: 12/037,987

(22) Filed: Feb. 27, 2008

(51) Int. Cl. B05D 3/00; C09D 1/00

(52) U.S. Cl. 427/229; 106/286.1; 106/286.5; 106/286.2; 524/401

(57) ABSTRACT

The present application provides improved diffusion coating compositions and improved methods for diffusion coating metal surfaces. The composition includes (a) a coating powder; and (b) a binder, wherein the coating powder comprises at least one metal, and wherein the binder will release an activator gas during vaporization or combustion. The method includes the steps of (a) providing a substrate; (b) applying a diffusion coating composition to at least a portion of the substrate, wherein the composition comprises a coating powder and a binder, the coating powder comprising at least one metal; and (c) vaporizing or combusting at least a portion of the composition so as to vaporize or combust at least a portion of the binder to produce an activation gas and vaporize at least a portion of the metal to form a coating of the metal on the substrate.

### TECHNICAL FIELD

The present application relates to diffusion coating systems and more particularly relates to diffusion coating systems for enhancing the coating of internal surfaces.

### BACKGROUND OF THE INVENTION

Generally described, the internal cavities of turbine components may be difficult and/or expensive to coat. These internal cavities may include a wide range of intricate surfaces on which it is difficult to produce a consistent coating thickness, and from which it is difficult to remove the waste materials produced during the coating process. Unfortunately, service exposed turbine components may be even more difficult to coat than original equipment manufacturer (OEM) components, since these components may contain surfaces that are unclean, partially oxidized, or covered with residual coating.

A variety of methods currently exist for coating OEM and service exposed turbine components. For example, one method for coating turbine components is the relatively inexpensive cementation pack process. Unfortunately, this method may be unable to produce a consistent coating thickness on intricate features such as small internal cooling holes and cavities. Furthermore, these intricate features may become difficult to reopen following the coating process. The cementation pack process can result in waste materials such as residual powder and ash that are difficult to remove and dispose.

Another method for coating turbine components is chemical vapor deposition (CVD). Although this method may be able to produce a consistent coating thickness, the CVD process and equipment can be prohibitively expensive.

What is desired, therefore, is a coating process that can provide a more consistent coating thickness on a variety of turbine components. The coating process may be inexpensive, and/or may provide a consistent coating thickness on a wide variety of intricate geometries that may be partially oxidized, unclean, or covered with residual coating. The process also may provide for a simple coating injection, produce less waste material, and/or allow for the simple and consistent removal of waste materials such as residual powder and ash.

### BRIEF DESCRIPTION OF THE INVENTION

The present application thus provides a diffusion coating composition and a method for diffusion coating a turbine component. The composition may include (a) a coating powder; and (b) a binder, wherein the coating powder comprises at least one metal, and wherein the binder will release an activator gas during vaporization or combustion. The method may include the steps of (a) providing a substrate; (b) applying a diffusion coating composition to at least a portion of the substrate, wherein the composition comprises a coating powder and a binder, the coating powder comprising at least one metal; and (c) vaporizing or combusting at least a portion of the composition so as to vaporize or combust at least a portion of the binder to produce an activation gas and vaporize at least a portion of the metal to form a coating of the metal on the substrate.

These and other features of the present application will become apparent to one of ordinary skill in the art upon review of the following detailed description when taken in conjunction with the appended claims.

### DETAILED DESCRIPTION OF THE INVENTION

The present application provides improved diffusion coating compositions and improved methods for diffusion coating metal surfaces. According to a particular embodiment, the present application may provide compositions and methods for diffusion coating gas turbine components.

In a certain embodiment, the diffusion coating composition may be flowable, and may include (1) a coating powder comprising a metal and (2) a binder. In another embodiment, the composition may further include an additive.

According to certain embodiments, the method may include the steps of (a) providing a substrate; (b) applying a diffusion coating composition to at least a portion of the substrate, wherein the composition comprises a coating powder and a binder, the coating powder comprising at least one metal; and (c) vaporizing or combusting at least a portion of the composition so as to vaporize or combust at least a portion of the binder to produce an activation gas and vaporize at least a portion of the metal to form a coating of the metal on the substrate. The method also may include the step of (d) removing a waste material from the turbine component.

The diffusion coating composition and diffusion coating process may improve the substrate's ability to withstand high temperatures. In particular, the process may form a chemically bonded coating that improves the substrate's resistance to oxidation, sulfidation, and/or corrosion. The diffusion coating may protect the substrate by forming a barrier against the diffusion of foreign elements into the substrate.

The Substrate

The compositions and methods described herein may be useful for diffusion coating essentially any substrate. The compositions and methods especially may be useful for diffusion coating substrates that are used in severe operating conditions. For example, the substrate may be a gas turbine component, a power generation component, or a diesel engine component. In particular embodiments, the compositions and methods may be used on substrates that are exposed to the extremely high operating temperatures. For example, the compositions and methods may be used on gas turbine components including turbine blades, buckets, vanes, cases, seals, nozzles, and shroud tiles. Substrates suitable for coating with the compositions and methods described herein may comprise alloys. For example, the substrate may comprise alloys of nickel (Ni), cobalt (Co), iron (Fe), or molybdenum (Mo).

The substrates may include a surface portion, and also may include one or more internal cavities. The internal cavities may include a wide range of intricate surfaces such as small holes. The substrate may be either an OEM component, or a service exposed component. In those embodiments where the substrate is a service exposed component, portions of the substrate may be unclean, partially oxidized, or include residual coating.

The Flowable Coating Composition

The composition may comprise a coating powder, a binder, and, optionally, an additive.

The coating powder may contain a metal capable of forming a chemical bond with the substrate. The metal may bond to the substrate so as to form a protective barrier against the diffusion of foreign elements into the substrate. The barrier may prevent the diffusion of elements such as oxygen so as to protect the substrate from oxidation, sulfidation, and/or corrosion.

According to particular embodiments, the coating powder may include at least one metal selected from the group of aluminum, platinum aluminum, chromium aluminum, aluminum silicon, MCrAlY, or combinations thereof. MCrAlY comprises at least one of iron, cobalt, or nickel (M=Fe, Co, and/or Ni); chromium; aluminum; and yttrium. According to certain embodiments, the coating powder may be present in the composition in an amount sufficient to (1) produce a coat thickness in the range of about 0.00003 inches to about 0.007 inches; and (2) produce a coat with percentage of aluminum in the range of about 12% to about 50% aluminum. According to particular embodiments, the coating powder may be present in the composition in an amount in the range of about 5% by weight to about 60% by weight of the composition.

The binder may comprise a braze gel binder. In the preferred embodiment, the viscosity of the binder is such that the composition will (1) flow during application to the substrate; and (2) remain in place after the application to the substrate. Importantly, the binder may cause the composition to release an activator gas (described below) during the vaporizing or combusting step. According to particular embodiments, the binder is present in the composition in an amount in the range of about 20% by weight to about 50% by weight of the composition. Non-limiting examples of suitable binders include water based binders, alcohol based binders, epoxy based binders, and combinations thereof.

The binder also may comprise at least one additive. The additive may enhance the generation of activation gas (described below) during the vaporizing or combusting step. According to particular embodiments, the additive may comprise at least one of polymethyl methacrylate (PMMA) micro beads, aluminum oxide, calcined aluminum oxide, ammonium fluoride (NH₄F), ammonium chloride (NH₄Cl), and Teflon chips. The additive may be present in the composition in an amount in the range of about 1% by weight to about 20% by weight of the composition.

The Coating Method

The step of applying the coating composition to the substrate may comprise essentially any suitable technique known in the art. Techniques suitable for applying the coating composition include injection, submersion, dipping, and vacuuming. In a preferred embodiment, the step includes injecting the composition into at least one internal cavity of the substrate. Importantly, the viscosity of the composition may (1) allow the composition to flow into any internal cavities within the substrate; and (2) allow the composition to remain in place after the application to the substrate.

The coating method may include the step of vaporizing or combusting at least a portion of the composition so as to (1) vaporize or combust at least a portion of the binder to produce an activation gas, and (2) vaporize at least a portion of the metal to form a coating of the metal on the substrate. In a preferred embodiment, the step of vaporizing or combusting comprises a heat treatment. The heat treatment may take place in a furnace such as an air box furnace, and may take place at a temperature in the range from about 1400° F. to about 2100° F. and over a period of time in the range from about 1 hour to about 10 hours.

The step of vaporizing or combusting may cause the binder to produce an activator gas. The activator gas may improve the coating process by enhancing the diffusion of the metal onto the portion of the substrate. According to particular embodiments, the activator gas may comprise at least one of hydrogen, chlorine, fluorine, hydrogen chloride, hydrogen fluoride, or ammonium. Although the exact mechanism by which the activator gas enhances the coating process is unknown, it is believed that the activator gas may (1) clean the turbine component; (2) promote the uniform diffusion of the coating onto the surface of the turbine component, including any portions of the turbine component that may be unclean, partially oxidized, or include residual coating; (3) reduce the quantity of waste materials such as residual coating and ash; (4) allow for easier waste material removal from the turbine component; (5) burnish the turbine component; or any combination of the foregoing.

The coating method may also include the step of (d) removing a waste material from the turbine component. The waste material may comprise any remaining portion of the composition and/or any byproducts of the coating process such as residual powder and ash.

### EXAMPLES

A diffusion coating composition comprising by weight 30% chromium aluminum (100 mesh, 44% chromium, 56% aluminum), 40% braze gel binder, 5% ammonium chloride (NH₄Cl), 5% ammonium fluoride (NH₄F), 10% PMMA micro beads, and 10% calcined aluminum oxide (Al₂O₃, 100 mesh) was injected into the internal passages of a nickel based superalloy turbine blade. The turbine blade was heated in a furnace to 2000° F. for 4 hours, and the furnace was then shut off and allowed to cool to room temperature.

After cooling, the internal passages of the turbine blade were cleaned with standard shop compressed air. Water was then run through the internal passages to ensure that they were clear of any remnant material. The diffusion coating resulted in a 1.8 mil coating in the turbine passages comprising by weight 23% aluminide.

It should be understood that the foregoing relates only to the preferred embodiments of the present application and that numerous changes and modifications may be made herein without departing from the general spirit and scope of the invention as defined by the following claims and the equivalents thereof.

We claim:

1. A method for diffusion coating a substrate, comprising the steps of:
a) providing a substrate;
b) applying a diffusion coating composition to at least a portion of the substrate, wherein the composition comprises a coating powder and a binder, the coating powder comprising at least one metal; and
c) vaporizing or combusting at least a portion of the composition so as to vaporize or combust at least a portion of the binder to produce an activation gas and vaporize at least a portion of the metal to form a coating of the metal on the substrate.

2. The method of claim 1, wherein the step of providing a substrate comprises providing a turbine component.

3. The method of claim 2, wherein a portion of the turbine component has at least one area that is oxidized, unclean, or coated with residual coating.

4. The method of claim 1, wherein the step of applying the composition comprises injecting the composition.

5. The method of claim 1, wherein the coating powder is present in the composition in an amount from about 5% by weight to about 60% by weight of the composition.

6. The method of claim 1, wherein the at least one metal is selected from the group of aluminum, platinum aluminum, chromium aluminum, aluminum silicon, MCrAlY, or combinations thereof.

7. The method of claim 1, wherein the viscosity of the binder is such that the composition will (1) flow during the application step; and (2) remain in place after the application step.

8. The method of claim 1, wherein the binder is present in an amount in the range of about 20% by weight to about 60% by weight of the composition.

9. The method of claim 1, wherein the binder comprises a braze gel binder.

10. The method of claim 1, wherein the binder further comprises an additive.

11. The method of claim 10, wherein the additive is selected from the group of PMMA micro beads, aluminum oxide, calcined aluminum oxide, NH₄F, NH₄Cl, Teflon chips, or combinations thereof.

12. The method of claim 1, wherein the activation gas comprises at least one of hydrogen, chlorine, fluorine, or hydrogen chloride.

13. A diffusion coating composition, comprising:
a) a coating powder; and
b) a binder,
wherein the coating powder comprises at least one metal, and
wherein the binder will release an activator gas during vaporization or combustion.

14. The composition of claim 13, wherein the at least one metal is selected from the group of aluminum, platinum aluminum, chromium aluminum, aluminum silicon, MCrAlY, or combinations thereof.

15. The composition of claim 13, wherein the coating powder is present in the composition in an amount from about 5% by weight to about 60% by weight of the composition.

16. The composition of claim 13, wherein the binder comprises a braze gel binder.

17. The composition of claim 13, wherein the binder is present in the composition in an amount from about 20% by weight to about 60% by weight of the composition

18. The composition of claim 13, wherein the binder further comprises at least one additive.

19. The composition of claim 18, wherein the at least one additive is selected from the group of PMMA micro beads, aluminum oxide, calcined aluminum oxide, NH₄F, NH₄Cl, Teflon chips, or combinations thereof.

20. The composition of claim 18, wherein the at least one additive is present in the composition in an amount from about 1% by weight to about 20% by weight of the composition.
